(19) United States
(12) Patent Application Publication
(10) Pub. No.: US 2005/0231666 A1
(43) Pub. Date: Oct. 20, 2005

(54) Array substrate, manufacturing method thereof and display device having the same

(75) Inventors: Jin-Hong Kim, Seoul (KR); Sang-Il Kim, Suwon-si (KR); Chong-Chul Chai, Seoul (KR); Kyoung-Ju Shin, Yongin-si (KR); Mun-Pyo Hong, Seongnam-si (KR); Sung-Jin Hong, Seoul (KR)

Correspondence Address: MCGUIREWOODS, LLP, 1750 TYSONS BLVD, SUITE 1800, MCLEAN, VA, 22102, US

(73) Assignee: Samsung Electronics Co., Ltd

(21) Appl. No.: 11/105,535

(22) Filed: Apr. 14, 2005

(30) Foreign Application Priority Data
Apr. 16, 2004 (KR) 2004-26193

(51) Int. Cl. G02F 1/1343

(52) U.S. Cl. 349/114

(57) ABSTRACT

An array substrate comprises a pixel electrode and a reflective layer. The pixel electrode has an opening or a protrusion that make a plurality of LC domains when electric field is applied to the LC layer. The reflective layer is formed at the boundary of the LC domains. The plurality of the LC domains make the LCD have a wide viewing angle. The reflective layer make the domain boundary be a reflective mode of the LCD. The LCD can have a good display quality.

### CROSS REFERENCE TO RELATED APPLICATION

This application claims priority to and the benefit of Korean Patent Application No. 2004-026193, filed on Apr. 16, 2004, which is hereby incorporated by reference for all purposes as if fully set forth herein.

### BACKGROUND OF THE INVENTION

1. Field of the Invention

The present invention relates to a liquid crystal display (LCD), an array substrate that can implement wide viewing angle with back light and ambient light, and a manufacturing method of the array substrate and the LCD.

2. Discussion of the Background

A liquid crystal display (LCD) comprises a lower substrate, an upper substrate and a liquid crystal layer inserted between the upper substrate and the lower substrate. A thin film transistor (TFT) formed on the lower substrate is electrically coupled to a pixel electrode, a gate electrode and a data electrode. The upper substrate may comprise a common electrode and a color filter layer. The LCD displays images by applying electric field to the liquid crystal (LC) layer and controlling light intensity transmitting through the LC layer. The traditional LCD has narrow viewing angle compared to other displays like cathode ray tube (CRT) or plasma display panel (PDP). A vertically aligned (VA) LCD has a wide viewing angle. The VA LCD comprises a vertically aligned liquid crystal layer inserted between an upper substrate and a lower substrate, wherein the LC layer has a negative dielectric anisotropy. When electric field is not applied between the upper substrate and the lower substrate, the LC molecules are substantially aligned perpendicularly to the substrates, and the LCD displays black. If a predetermined electric field is applied between the upper substrate and the lower substrate, the LC molecules are substantially aligned parallel to the substrates, and the LCD displays white. If a weaker electric field than the electric field for white is applied between the upper substrate and the lower substrate, the LC molecules are inclined to the substrates, and the LCD displays gray.

More and more small and mid size LCDs adopt a reflective-transmissive type. Accordingly, one driving voltage is used for the reflective mode, and another driving voltage is used for the transmissive mode in the reflective-transmissive type LCD. Small and mid size LCDs display more and more information. Therefore, those small and mid size LCDs require a wider viewing angle and a higher definition.

### SUMMARY OF THE INVENTION

This invention provides an array substrate enhancing display quality by using domain boundaries of LC layer as reflective areas.

The present invention also provides a method for manufacturing the above mentioned array substrate.

An embodiment of the present invention provides an LCD having an LC layer, a first substrate, and a second substrate. A common electrode is formed on the first substrate. A plurality of first openings are formed in the common electrode. A pixel electrode is formed on the second substrate. A plurality of second openings are formed on the pixel electrode. A reflective layer is formed on the second substrate. The LC layer is confined between the first substrate and the second substrate. The reflective layer overlaps with the first openings and the second openings. The present invention enhances the display quality of an LCD by overlapping the reflective layer with the first openings and the second openings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a plan view of a reflective-transmissive mode LCD.

FIG. 2 shows a plan view of a PVA mode LCD.

FIG. 3 shows a cross-sectional view of a PVA mode LCD.

FIG. 4 shows a plan view of the embodiment 1 of the present invention.

FIG. 5 shows a cross-sectional view of A-A′ in FIG. 4.

FIG. 6 shows an arrangement of the LC molecules of the LCD in FIG. 4.

FIG. 7 shows transmissive character of the LCD in FIG. 4.

FIGS. 8, 9, 10, 11, 12, and 13 show a manufacturing process of the LCD of the embodiment 1 of the present invention.

FIG. 14 shows a plan view of the embodiment 2 of the present invention.

FIG. 15 shows a cross-sectional view of B-B′ of FIG. 14.

FIGS. 16, 17, 18, 19, 20, and 21 show a manufacturing process of the LCD of the embodiment 2 of the present invention.

FIG. 22 shows a plan view of the embodiment 3 of the present invention.

FIG. 23 shows a cross-sectional view of C-C′ of FIG. 22.

FIGS. 24, 25, 26, 27, 28, and 29 show a manufacturing process of the LCD of the embodiment 3 of the present invention.

FIG. 30 shows a plan view of the embodiment 4 of the present invention.

FIG. 31 shows a cross-sectional view of D-D′ of FIG. 30.

FIGS. 32, 33, 34, 35, 36, and 37 show a manufacturing process of the LCD of the embodiment 4 of the present invention.

### DETAILED DESCRIPTION OF THE ILLUSTRATED EMBODIMENTS

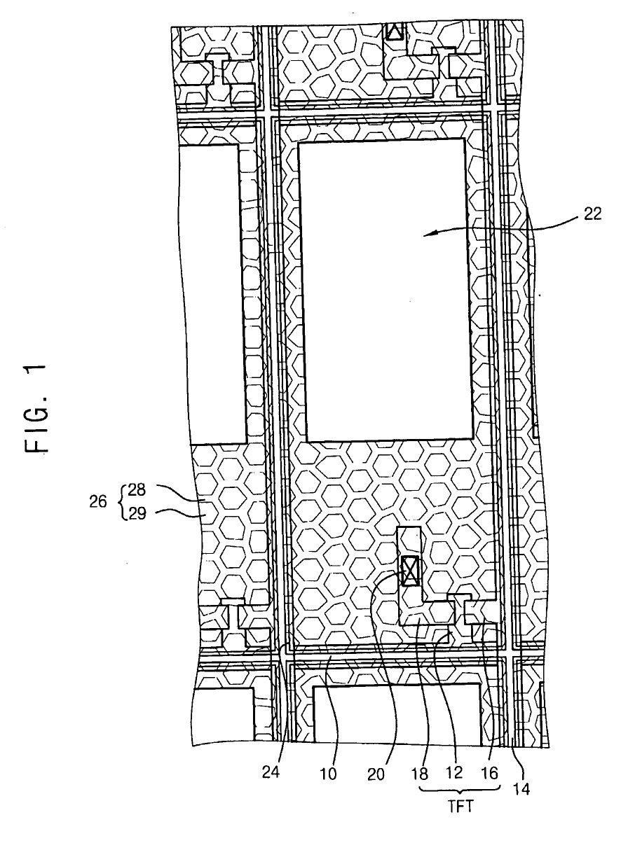

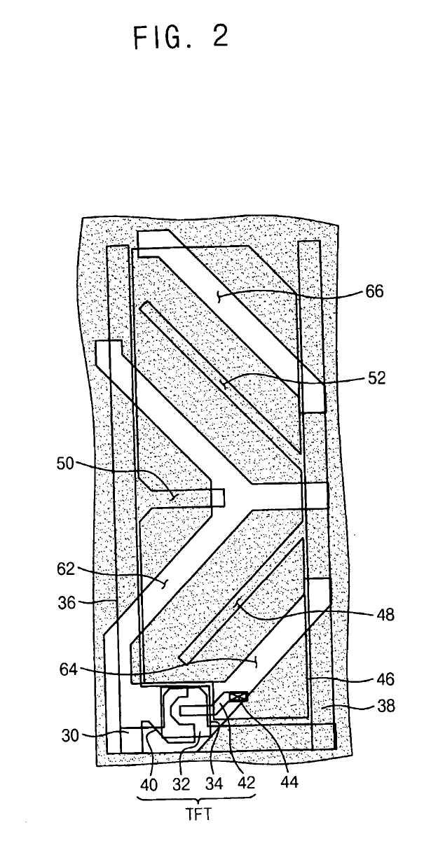

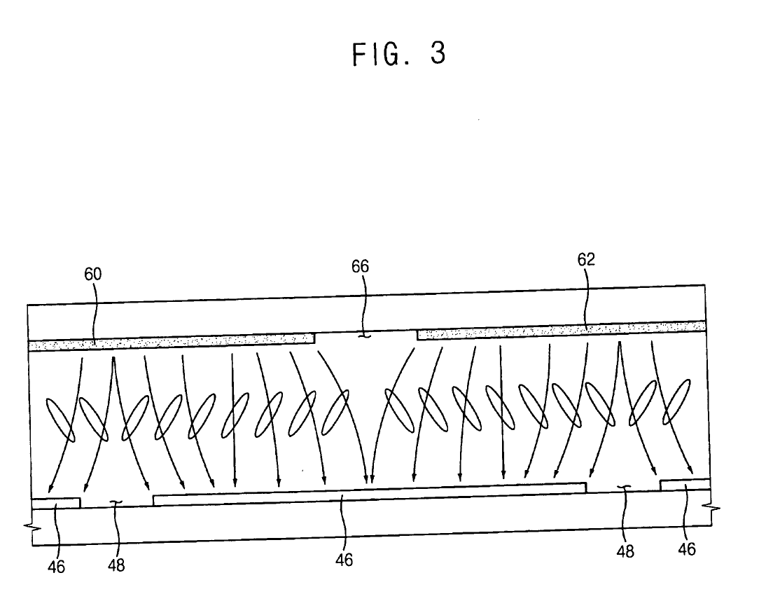

Hereinafter the concept and the principle of a reflective-transmissive mode LCD are described with reference to FIG. 1. The concept and the principle of a PVA mode LCD is also described with reference to FIG. 2 and FIG. 3. These concepts and principles may be applied to the present invention even though details are not described in the embodiments.

FIG. 1 shows a portion of an array substrate of a reflective mode LCD. A plurality of scan line 10 extends in parallel to a transversal direction. A plurality of data line 14 extends longitudinally in parallel. A thin film transistor (TFT) has a gate electrode 12 extending from a scan line 10, a source electrode 16 extending from a data line 14, a drain electrode 18 being apart from the source electrode 16. The drain electrode 18 is electrically coupled to a pixel electrode 24. A reflective area 26 and a transmissive window 22 are formed on the pixel electrode 24. The reflective area reflects ambient light. And the transmissive window transmits back light. A plurality of grooves 28 and a plurality of protrusion 29 formed on the reflective area 26 enhance reflectivity. This example shows a transmissive window and a reflective portion in one pixel area. One voltage is applied to the pixel electrode when the LCD is used as a reflective mode and another voltage is applied to the pixel electrode when the LCD is used as a transmissive mode to display the same image.

FIG. 2 and FIG. 3 show a pixel area of a PVA mode LCD. Portions of the pixel electrode layer 46 are removed, so the pixel electrode has an opening in an array substrate. Portions of a common electrode layer 62 are removed also, and the common electrode has openings. When electric field is applied between the pixel electrode and the common electrode, the LC molecules rotate according to the opening patterns and the LC molecules form LC domains. These multi domains allow the LCD to have a wide viewing angle. Because the electric field at the domain boundary is weaker than that of the domain area, the luminance efficiency at the domain boundary is low. If a reflective layer is formed at the domain boundary and the domain boundary works as a reflective mode, the luminance efficiency may be much better.

Because the other structures and materials are similar to the following embodiments of the present invention, detail description is omitted here. The notation is present for reference; pixel electrode 46, common electrode 62, scan line 30, data line 36, gate electrode 32, semiconductor layer 34, source electrode 40, and drain electrode 42.

### Embodiment 1

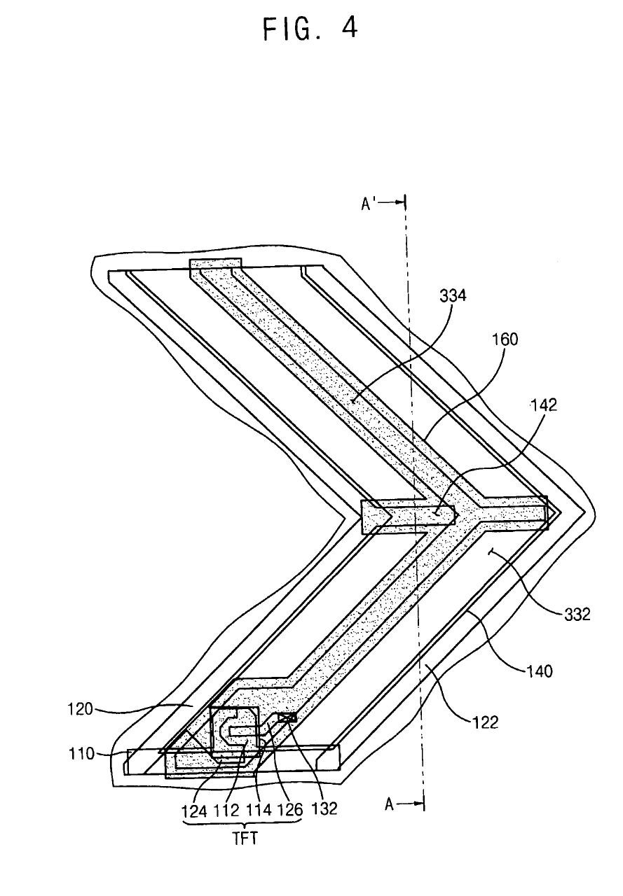

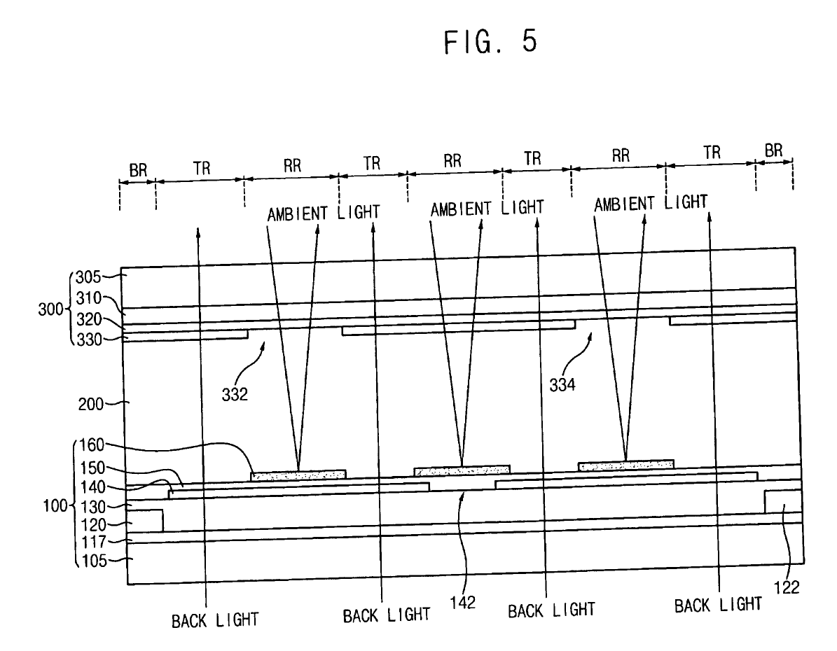

FIG. 4 and FIG. 5 show an array substrate 100, an LC layer 200 and a color filter substrate 300 assembled to the array substrate 100 to confine the LC layer 200 between the array substrate and the color filter substrate. The array substrate 100 comprises a transmissive substrate 105, a scan line 110 extending to a transverse direction, a gate electrode 112 extending from the scan line 110 and a first insulation layer 117 made of silicon nitride (SiNₓ), silicon oxide (SiOₓ), etc. The first insulation layer 117 covers the scan line 110 and the gate electrode 112. The array substrate 100 also comprises an active layer 114 covering the gate electrode 112, a data line 120 extending longitudinally and having bent portions, a source electrode 124 extending from the data line and a drain electrode 126 being apart from the source electrode 124. The gate electrode 112, the active layer 114, the source electrode 124 and the drain electrode 126 compose a thin film transistor (TFT). The data line has a vent portion in a unit pixel area and the pixel forms a “V” shape.

The scan line 110 and the data line 120 may be made of tantalum (Ta), titanium (Ti), molybdenum (Mo), aluminum (Al), chromium (Cr), copper (Cu), or tungsten (W). The scan line 110 and the data line 120 may form a double layer. Cr, Mo or molybdenum alloy may be a lower layer and Al or aluminum alloy may be an upper layer.

The array substrate 100 also comprises a second insulation layer 130 covering the TFT and exposing a portion of the drain electrode 126. The second insulation layer 130 protects the channel 114 of the TFT from contamination and damage.

The array substrate 100 also comprises a pixel electrode 140 electrically coupled to the drain electrode 130 through the contact hole 132. The pixel electrode 140 has an opening area 142 exposing a portion of the second insulation layer 130. The opening area 142 is parallel to the scan line 110 and opposing a portion of an axis dividing the pixel area into two equal parts. The opening area 142 is about 135 degree to the data line 110 extending a first direction, about −135 degree to the data line 110 extending a second direction which is substantially 90 degree to the first direction.

The array substrate 100 comprises a reflective area 160 covering the opening area 142 of the pixel electrode 140 and the opening area of the common electrode 330 on the color filter substrate 300. There may be an insulation layer 150 between the pixel electrode 140 and the reflective portion 160.

The color filter substrate 300 comprises a transmissive substrate 305, a color filter layer 310 formed on the transmissive substrate 305, a protection layer 320 protecting the color filter layer 310 and a common electrode 330 formed on the protection layer 320. The color filter substrate 300 is assembled with the array substrate 100 to confine an LC layer 200 between the color filter substrate 300 and the array substrate 100. Liquid crystal molecules in the LC layer are aligned vertically. The common electrode 330 has an opening pattern in a pixel area. The opening pattern in the common electrode 330 comprises a first opening area, a second opening area and a third opening area. The second opening area is almost a mirror image of first opening area against an axis parallel to the scan line 110, and the axis divide the pixel area into two equal parts. The third opening area corresponds with the axis. The first opening area abuts the second opening area at about 90 degree. The third opening area is about 135 degree from the first opening area.

In a plan view, a pixel of the LCD of this embodiment shows upper right domain, upper left domain, lower right domain and lower left domain by the opening pattern of the pixel electrode and the common electrode. The LC molecules in each domain tilt in four different directions according to the opening pattern, which realize a wide viewing angle.

Because the electric field in the opening area is weaker than that of the domain area when electric field is applied to the pixel area, the luminance in the opening area is dimmer than that of the domain area when it is used as a transmissive LCD. When a reflective layer is formed in the opening area, the opening area of the LCD becomes a reflective-transmissive mode, and the efficiency of the opening area becomes better.

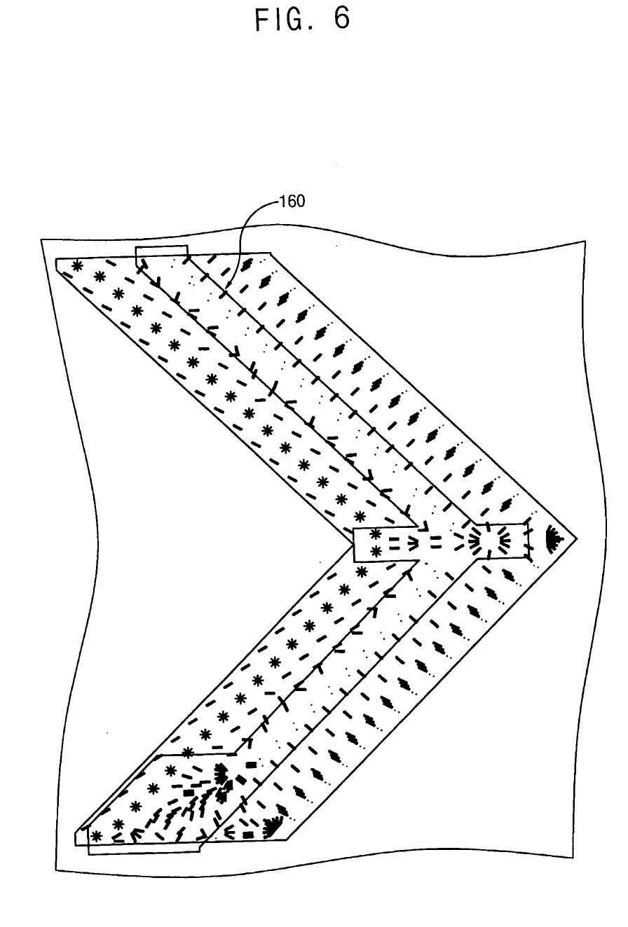

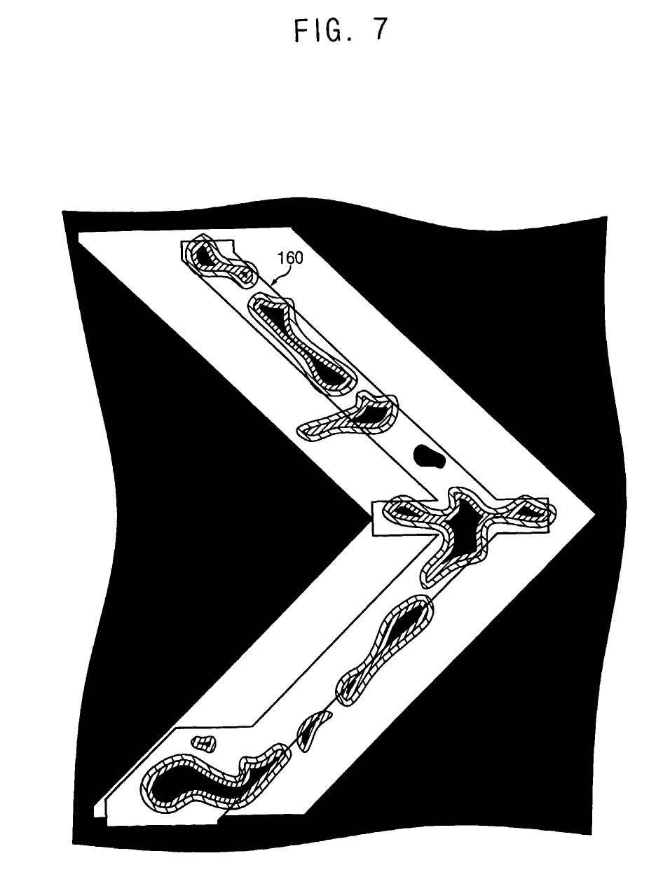

FIG. 6 shows a simulation result of the present embodiment described in FIG. 4. It shows how the LC molecules tilt when electric field is applied to the LC layer. FIG. 7 shows the transmission character of the embodiment shown in FIG. 4.

The LC molecules do not lie enough for a transmissive mode at the boundaries of the domains, which is better for a reflective mode. If a reflective layer is formed in the boundary area of the domains, it can be brighter in that area.

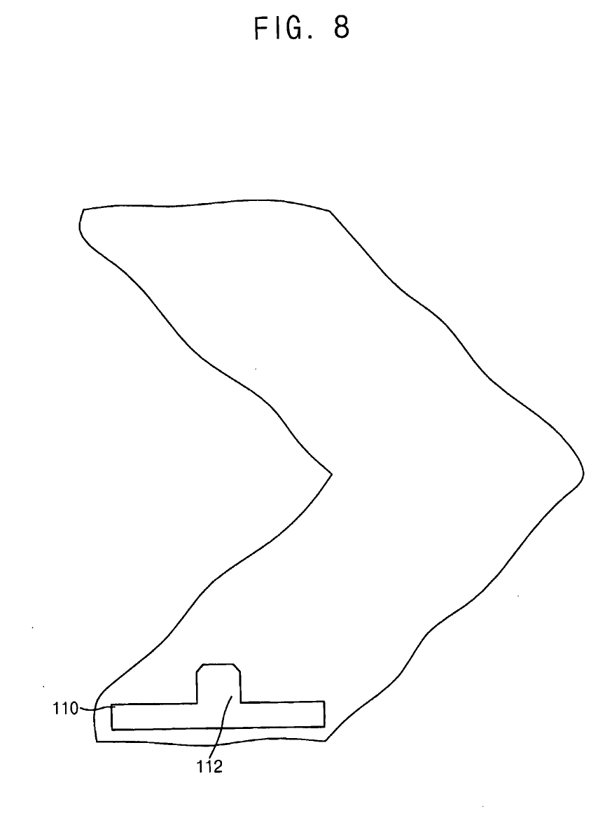

FIGS. 8, 9, 10, 11, 12, and 13 show a method for manufacturing an embodiment of the present invention. A metal layer is formed on a transmissive substrate 105 like glass, ceramic, etc. The metal layer is made of Ta, Ti, Mo, Al, Cr, Cu or W. The metal layer is patterned to form a plurality of scan lines 110, a plurality of gate electrode 112 extending from the scan line 110. A first insulation layer 117 is formed on the substrate 105, the scan lines 110 and the gate electrode 112. The first insulation layer 117 is made of silicon nitride, and formed by chemical vapor deposition (CVD) method.

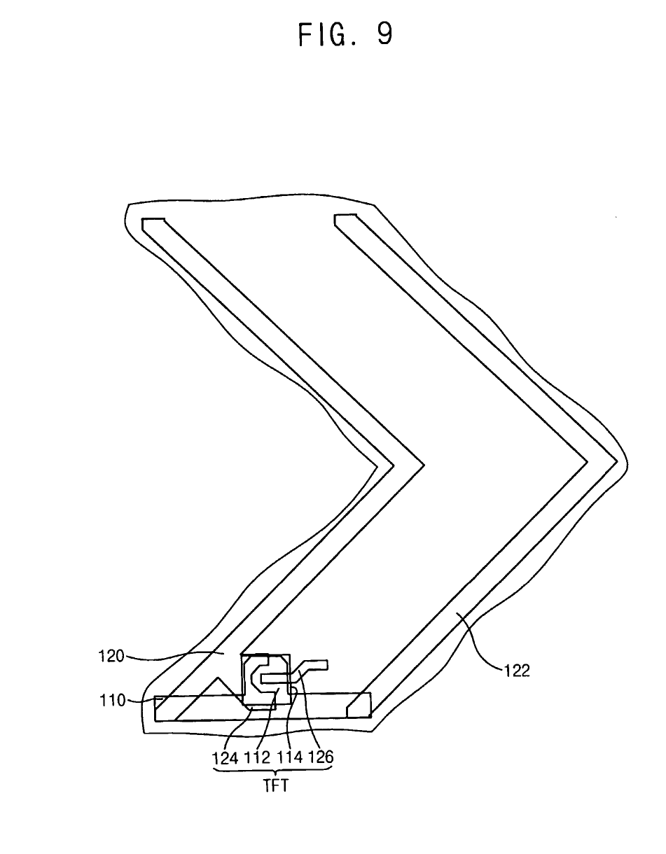

FIG. 9 shows that an amorphous silicon layer is formed on the first insulation layer 117. An n⁺ amorphous silicon (a-Si) layer is formed on the amorphous silicon layer. The a-Si layer and the n⁺a-Si layer are patterned and make an active layer 114 on the gate electrode 112. A data line 120, a source electrode 124 and a drain electrode 126 are formed on the second insulation layer and on the n⁺ a-Si layer. The data line 120, the source electrode 124 and the drain electrode 126 may be made of Ta, Ti, Mo, Al, Cr, Cu or W. The data line 120 extends longitudinally and has one bent portion in a unit pixel area. The bent angle is about 90 degree. The source electrode 124 extends from the data line 120. The drain electrode 126 is formed apart from the source electrode 124.

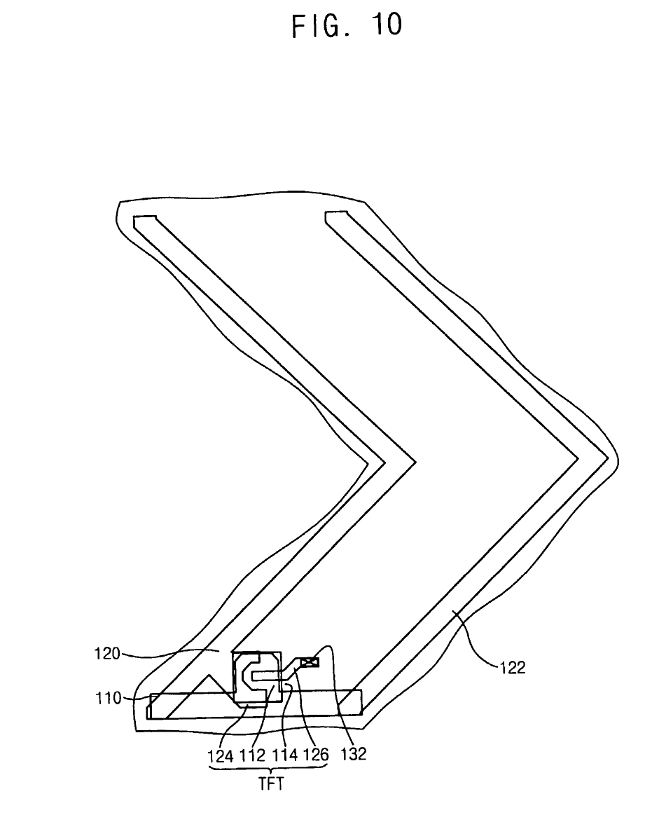

FIG. 10 shows that a second insulation layer 130 (shown in FIG. 5) is coated on the result substrate of the FIG. 9. The coating step may adopt spin coating method. A contact hole 132 is formed in the second insulation layer and exposes a portion of the drain electrode 126.

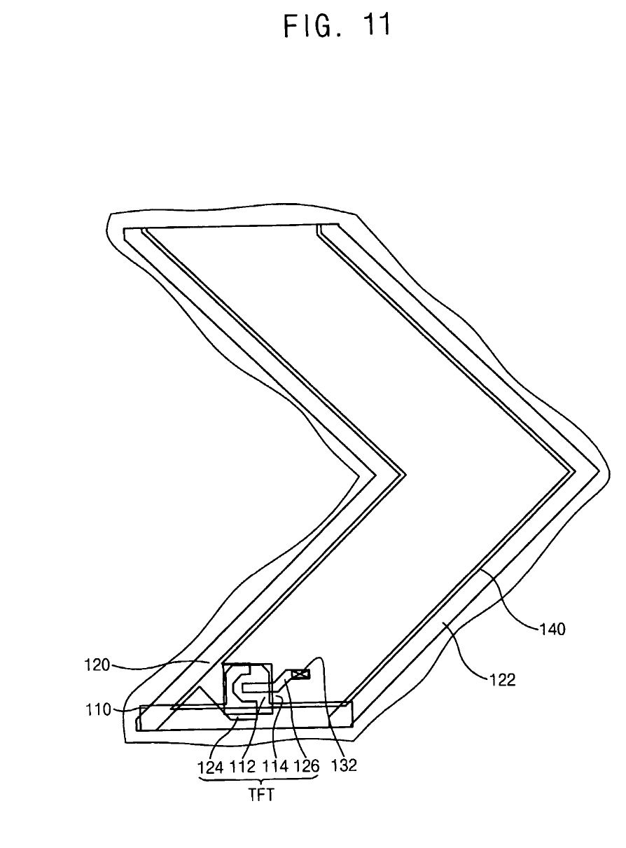

FIG. 11 shows that a pixel electrode 140 is formed in a pixel area. The pixel electrode 140 is electrically coupled to the drain electrode 126. The coupling may be through the contact hole 132. The pixel electrode 140 may be made of a transparent electrode like indium tin oxide (ITO), indium zinc oxide (IZO), zinc oxide (ZO), etc. The pixel electrode 140 may be formed by depositing an electrode layer on the whole substrate and patterning the electrode layer to pixel electrode. The pixel electrode 140 may be formed by depositing the pixel electrode shape directly. Though the pixel electrode 140 overlaps with the scan line 110 and the data line 120 in FIG. 11, the pixel electrode 140 may not overlap with the scan line 110 and the data line 120.

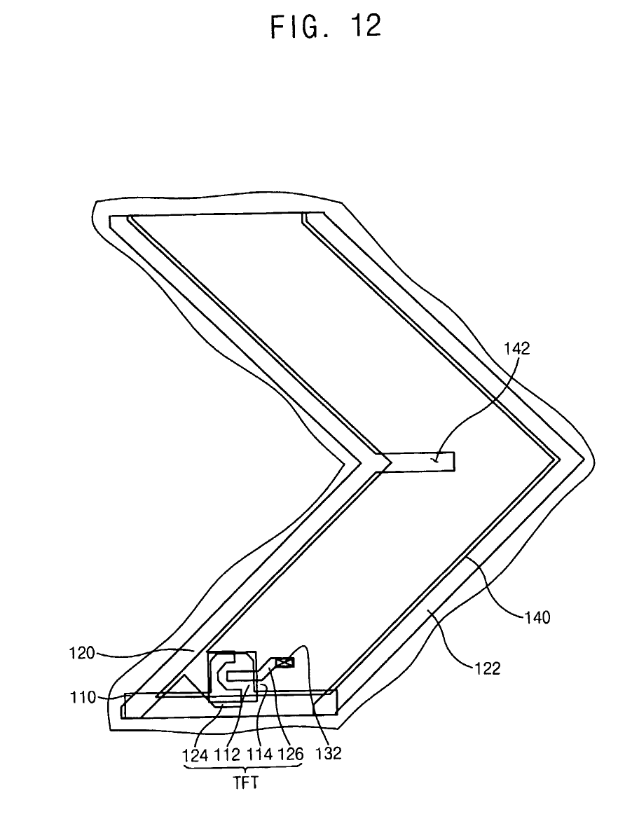

As show in FIG. 12, the pixel electrode layer 140 may be removed in a portion of the bending area 142. FIGS. 11 and 12 show that the bending area 142 is removed after the pixel electrode 140 is formed. The step shown in FIG. 12 may be done in the same step as the step shown in FIG. 11.

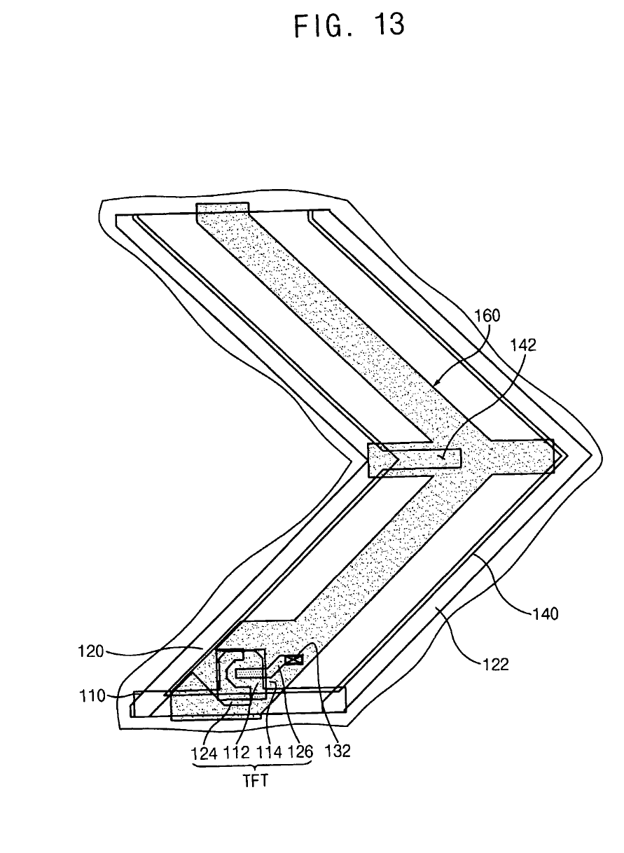

FIG. 13 shows that a third insulation layer 150 is formed on the pixel electrode 140. A reflective layer 160 is formed on the third insulation layer 150. The reflective layer 160 may be formed on the pixel electrode 140 directly without forming the third insulation layer 150. The reflective layer 160 is formed in the opening area of the pixel electrode 140 and the opposing area of the opening area of the common electrode 330 on the color filter substrate 300 as shown in FIG. 4.

The reflective layer 160 is formed to cover the first opening, the second opening and the third opening in the common electrode 330 in a plan view. The reflective layer also covers the bending portion of the pixel area as shown in FIG. 4. The reflective layer may be formed between the pixel electrode layer and the second insulation layer or even between the transmissive substrate and the pixel electrode layer.

### Embodiment 2

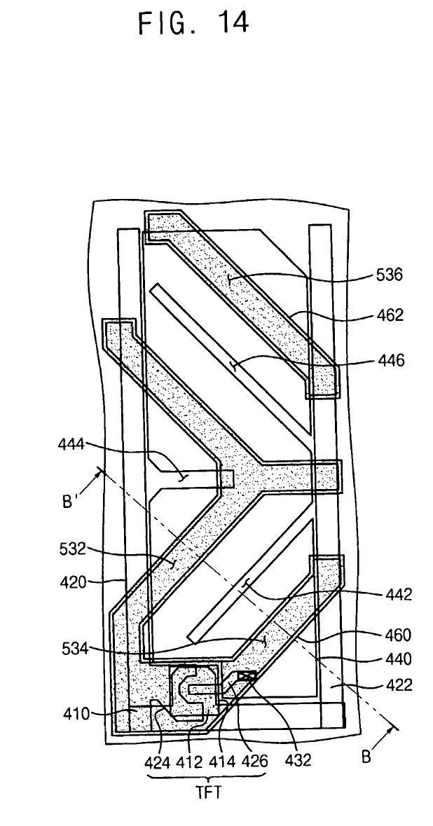

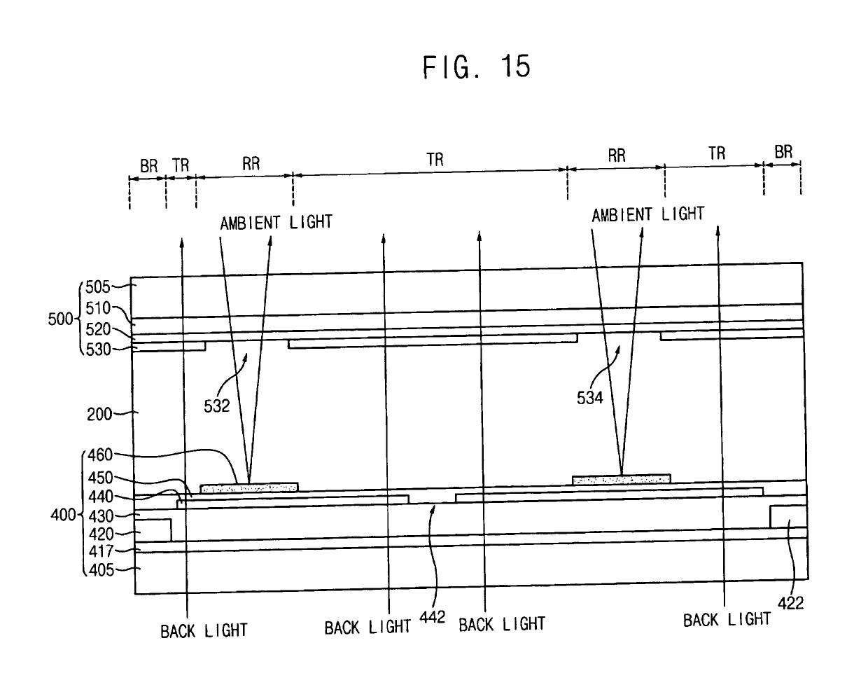

FIGS. 14 and 15 show another embodiment of an array substrate 400. A scan line 410 extends transversely on a transmissive substrate 405. A gate electrode 412 extends from the scan line 410. A first insulation layer 417 made of silicon nitride (SiNₓ), etc covers the scan line 410 and the gate electrode 412. An active layer 414 covers the gate electrode 412. A data line 420 extends longitudinally. A source electrode 424 extends from the data line 420. A drain electrode 426 is formed apart form the source electrode 424. The gate electrode 412, the active layer 414, the source electrode 424 and the drain electrode 426 form a TFT. A second insulation layer 430 is formed on the source electrode, the drain electrode and the active layer. A portion of the second insulation layer 430 is removed to form a contact hole 432. A pixel electrode 440 is formed on the second insulation layer 430 and electrically coupled to the drain electrode 426. A first opening 442, a second opening 444 and a third opening 446 is formed in the pixel electrode 440. In a plan view, the first opening 442 is a stripe being about 45 degree counterclockwise from the scan line 410. The second opening 444 is a stripe being parallel with the scan line 410 and formed in the portion dividing the pixel area into substantially two equal parts. The third opening 446 is a stripe being about 45 degree clockwise from the scan line 410. The openings don't electrically isolate any part of the pixel electrode from the other part in a pixel area. The array substrate 400 includes a reflective layer overlapping the openings in the pixel electrode and the openings in the common electrode 530 on the color filter substrate 500 in plan view. The reflective layer 560 may cover a portion of the data line 420. An insulation layer 450 may be formed between the pixel electrode layer 440 and the reflective layer 560.

A color filter substrate 500 comprises a transmissive substrate 505, a color filter layer 510, a protection layer 520, and a common electrode 530. The color filter substrate 500 is assembled with the array substrate 400 to confine an LC layer between the array substrate and the color filter (CF) substrate. The LC molecules in the LC layer are aligned vertically to the surface of the CF substrate. The CF layer 510 is formed on the transmissive substrate 505. The protection layer 520 is formed on the CF layer 510. The common electrode 530 is formed on the protection layer 520. Portions of the common electrode 530 are removed to form openings in a pixel area. The openings in the common electrode 530 comprise a first opening, a second opening, and a third opening. The first opening is parallel with the scan line 410, and corresponds to an axis dividing the pixel area into two equal parts. The second opening is about 135 degree to the clockwise direction from the first opening. The third opening is about 135 degree to the counter-clockwise direction from the first opening. A fourth opening extends from the second opening and overlaps a portion of the data line. A fifth opening extends from the fourth opening, and overlaps a portion of the TFT. A sixth opening extends from the fifth opening being 45 degree from the scan line. The sixth opening overlaps a data line 422. A seventh opening is formed as a mirror image from the sixth opening against the axis dividing the pixel area into two equal parts.

As shown in the FIG. 14, the pixel area is divided into 8 domains by the openings in the pixel electrode and the common electrode. In the opening area, electric field is weaker than other area when electric field is applied between the pixel electrode and the common electrode. Similar to the embodiment 1 of the present invention, a reflective layer is formed to correspond to the opening area.

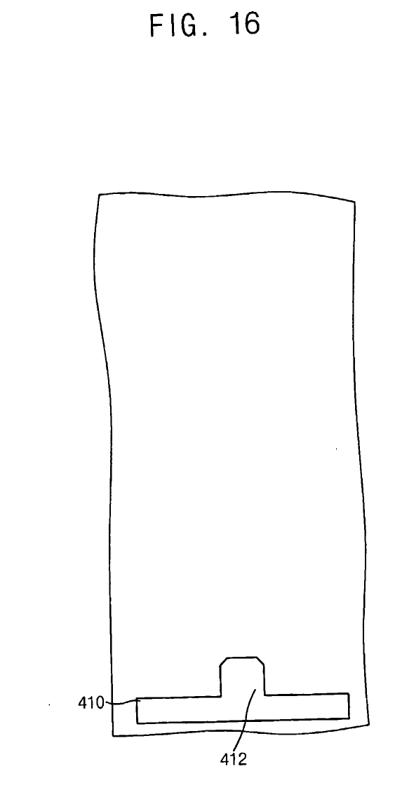

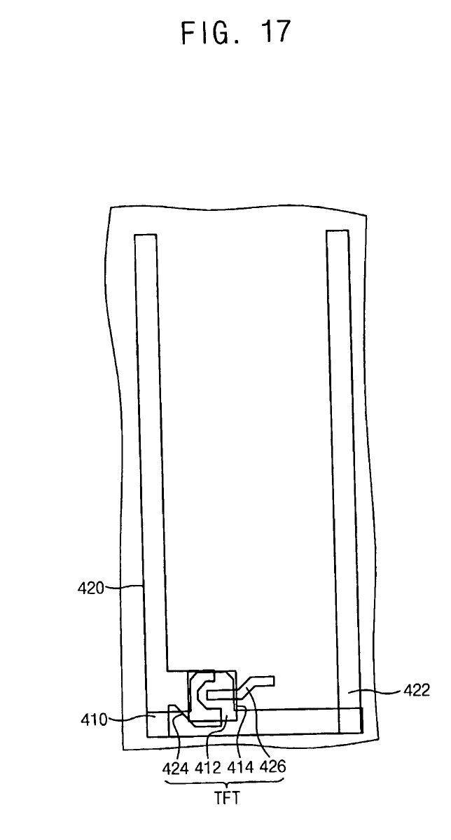

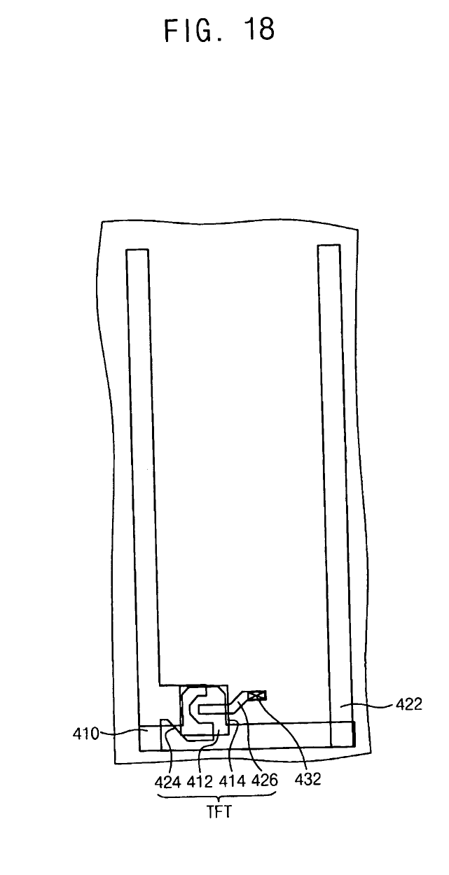

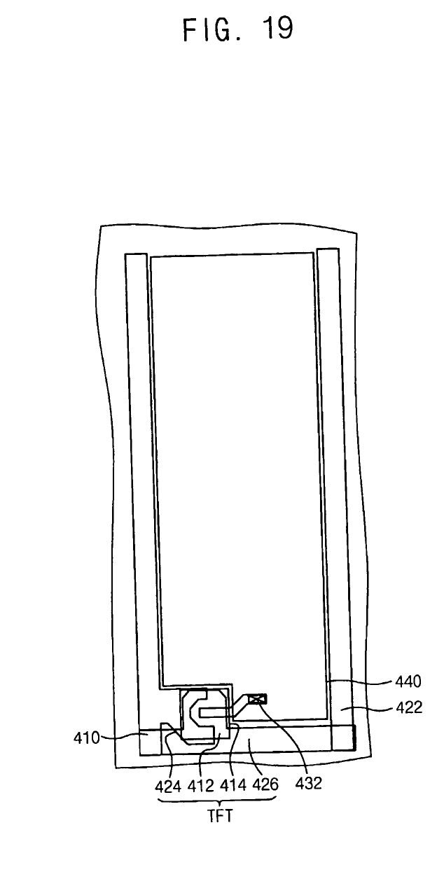

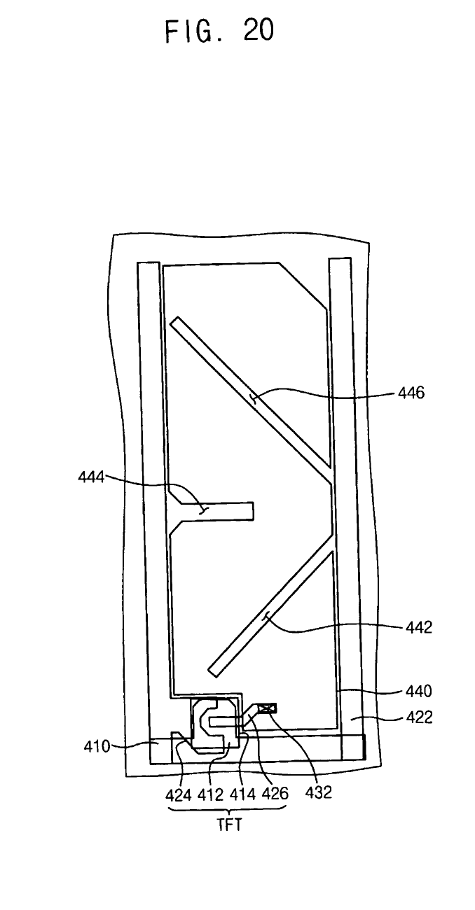

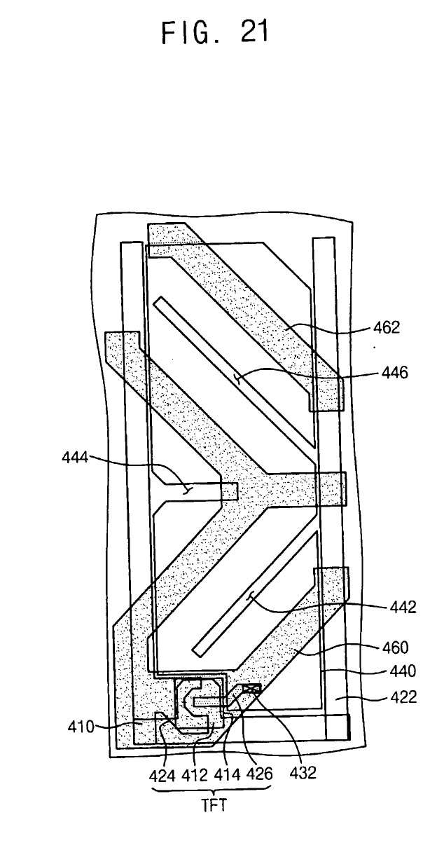

FIGS. 16, 17, 18, 19, 20, and 21 show a method for manufacturing the above embodiment. Because the steps for manufacturing this embodiment are similar to the embodiments 1 and 2 of the present invention, no further descriptions are provided in detail.

### Embodiment 3

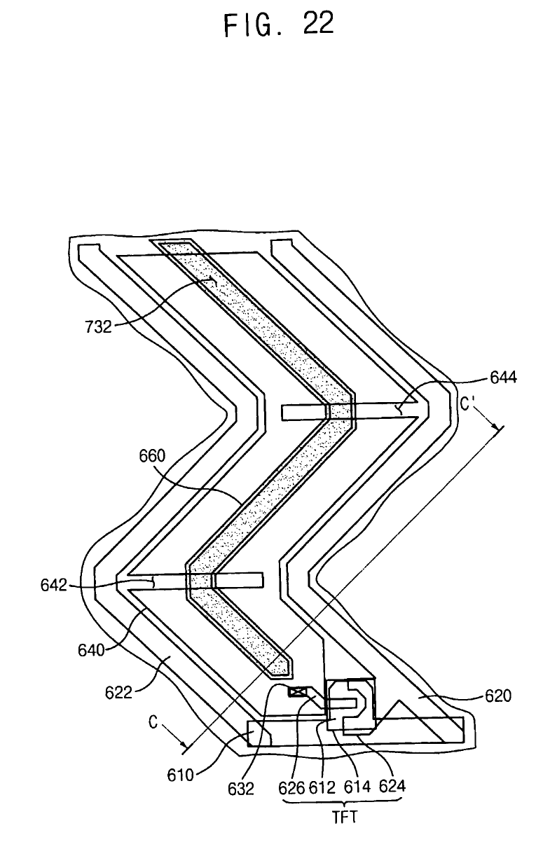

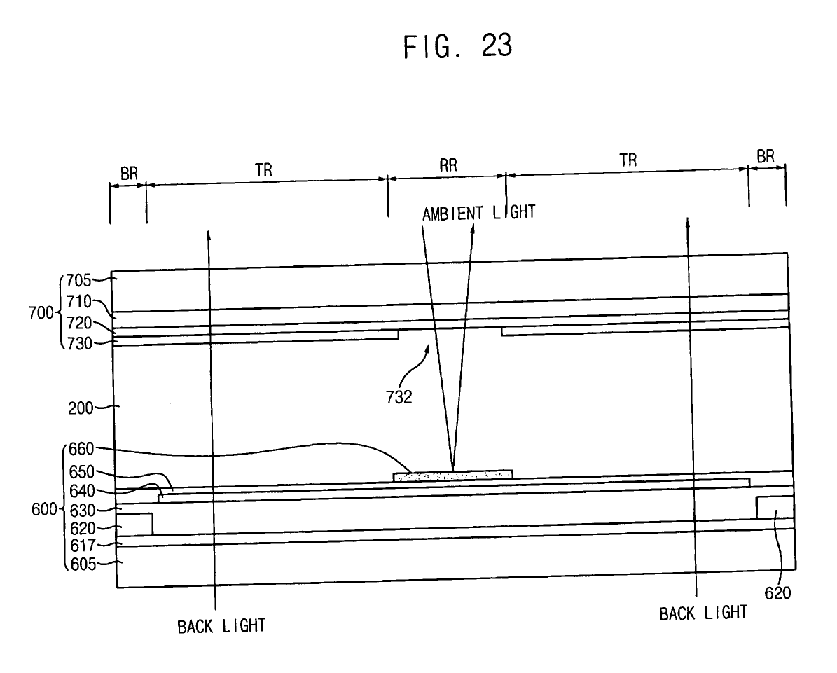

FIGS. 22 and 23 show a third embodiment of the present invention. The pixel of the present embodiment shapes “Z”. The data line 620 of the present embodiment has two bent portion in a unit pixel area and extends longitudinally. The pixel electrode 640 of this embodiment exposes portions of a second insulation layer 630 through a first opening 642 and a second opening 644. In a plan view, the first opening 642 is a stripe that is parallel with the scan line 610 and formed in the left side of the pixel electrode. The second opening 644 is a stripe that is parallel with the scan line 610 and formed in the right side of the pixel electrode.

An opening 732 extending longitudinally is formed in a common electrode 730. The opening 732 locates in the middle of the pixel electrode and has two bending portions similar to the data lines 620 and 622. The width of the opening in the common electrode may be bigger than, less than or equal to about third of the width of the whole pixel electrode.

In a plan view, the pixel area is divided into 6 domains by the openings in the pixel electrode and the common electrode. Forming a reflective layer at the domain boundaries and its vicinity may utilize the inefficient area to be a reflective mode area.

Because the other structures and materials are similar to the embodiments 1 and 2 of the present invention, detail description is not further provided. The notation is present for reference; array substrate 600, transmissive substrate 605, scan line 610, gate electrode 612, first insulation layer 617, gate electrode 612, active layer 614, data line 620, second insulation layer 630, pixel electrode 640, reflective layer 660, LC layer 200, color filter substrate 700, common electrode 730, transmissive substrate 705, color filter layer 710, protection layer 720, common electrode opening 732, first opening 642, second opening 644, contact hole 632, drain electrode 626, gate electrode 612, active layer 614, source electrode 624, data line 622, third insulation layer 650, reflective range RR, transmissive range TR, and blocking range BR.

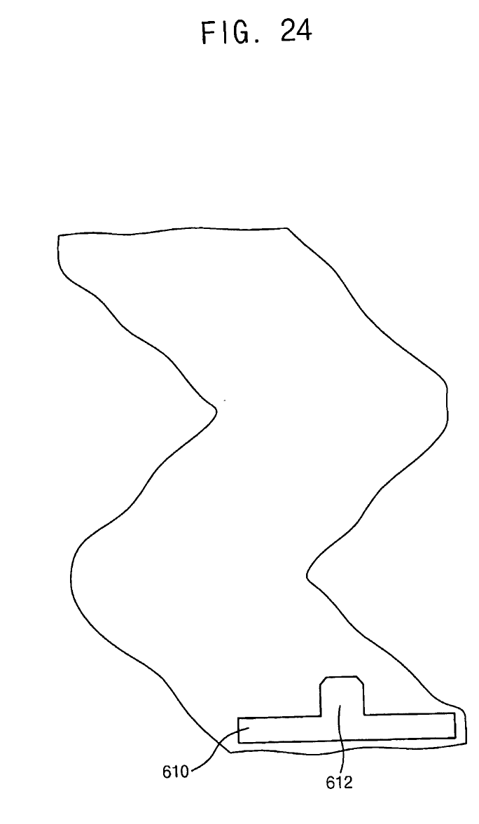

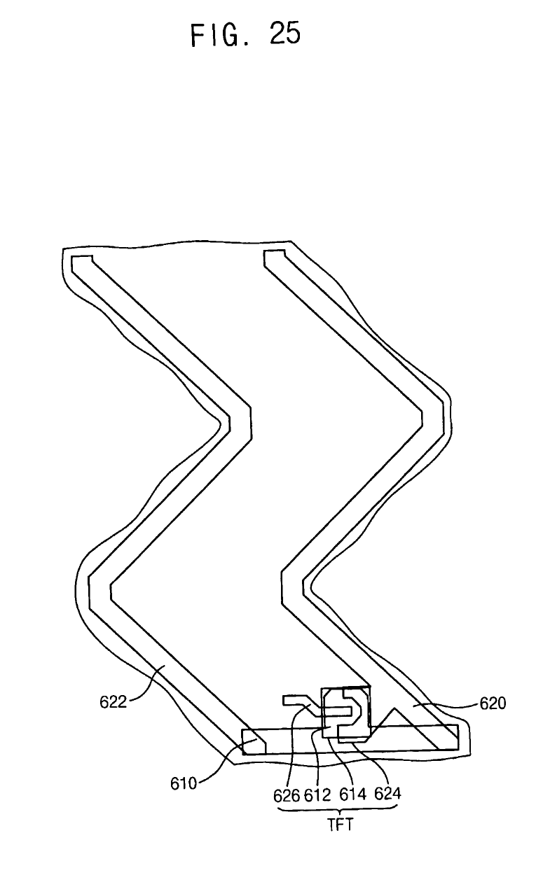

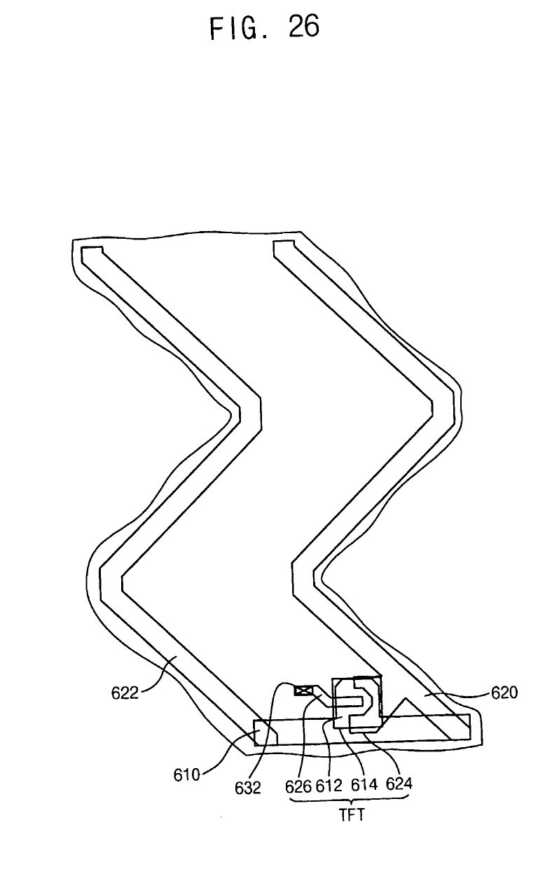

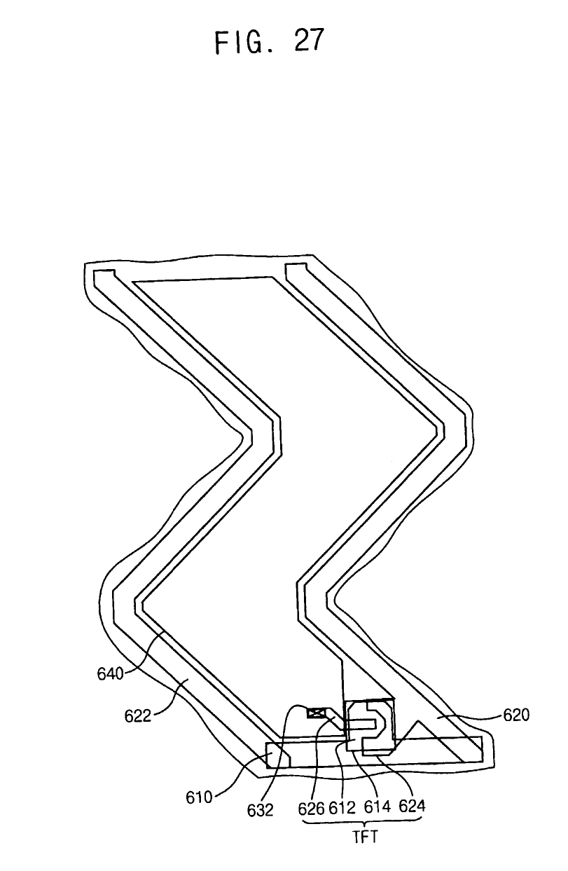

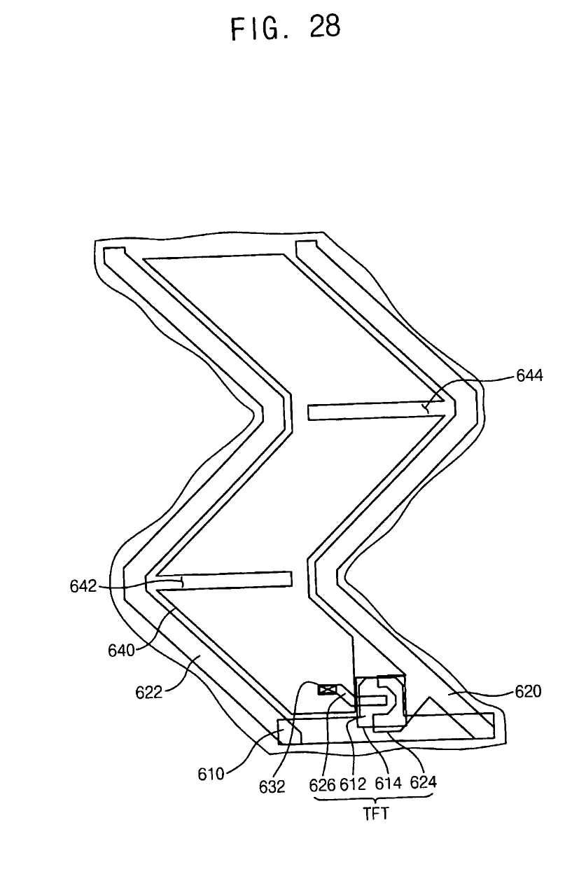

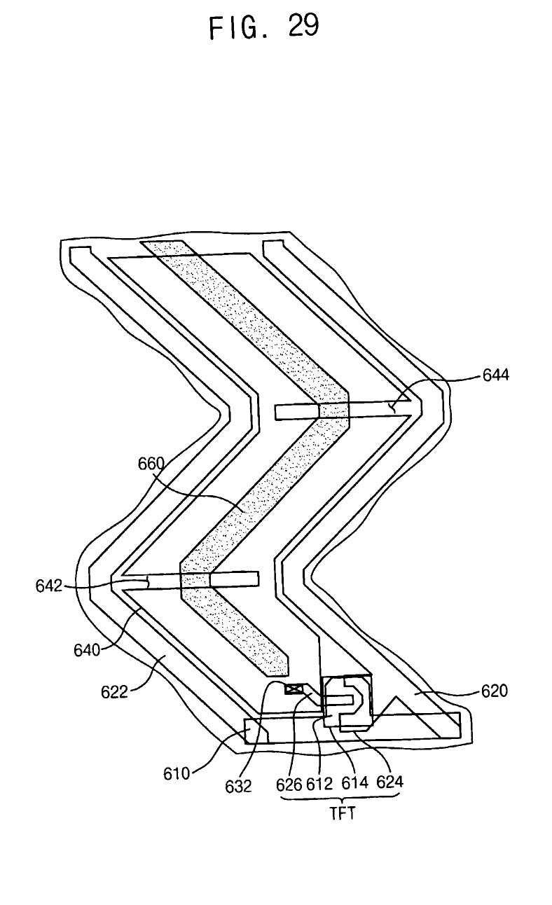

FIGS. 24, 25, 26, 27, 28, and 29 show steps for manufacturing the above embodiment. Because the steps for manufacturing this embodiment are similar to the embodiments 1 and 2 of the present invention, detail description is omitted here.

### Embodiment 4

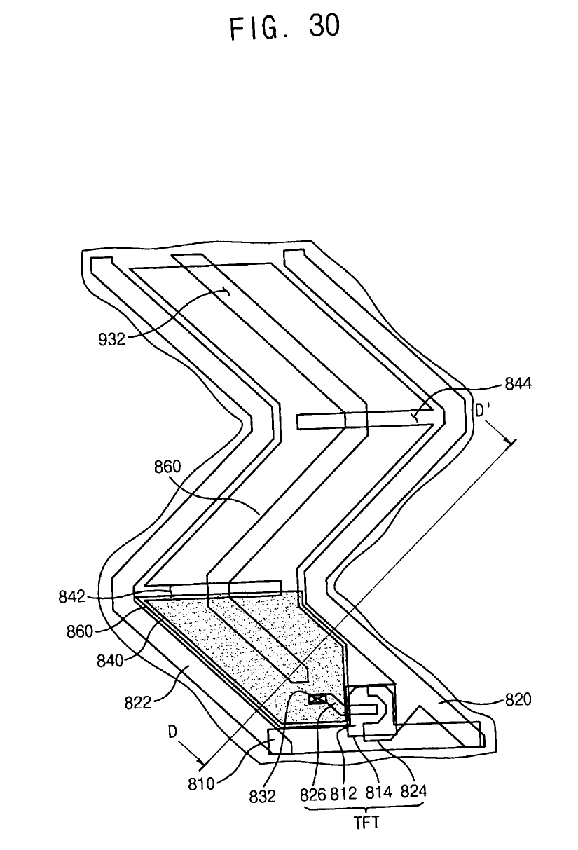

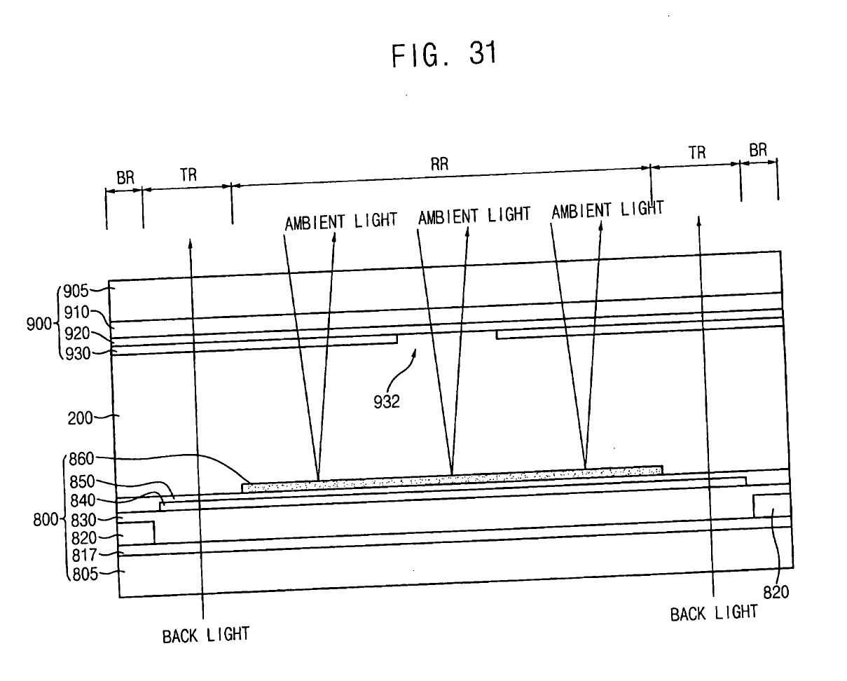

FIGS. 30 and 31 show the forth embodiment of the present invention. The pixel of the present embodiment also shapes “Z”. Though reflective area covers two domains closest to the TFT in this embodiment, the reflective area may cover any two domains of the six. A reflective layer may be formed at a portion of the domain boundary and its vicinity additionally.

Because the other structures and materials are similar to the embodiments 3 of the present invention, detail description is omitted here. The notation is present for reference; array substrate 800, transmissive substrate 805, scan line 810, gate electrode 812, first insulation layer 817, gate electrode 812, active layer 814, data line 820, second insulation layer 830, pixel electrode 840, reflective layer 860, LC layer 200, color filter substrate 900, common electrode 930, transmissive substrate 905, color filter layer 910, protection layer 920, common electrode opening 932, first opening 842, second opening 844, contact hole 832, drain electrode 826, gate electrode 812, active layer 814, source electrode 824, data line 822, third insulation layer 850, reflective range RR, transmissive range TR, and blocking range BR.

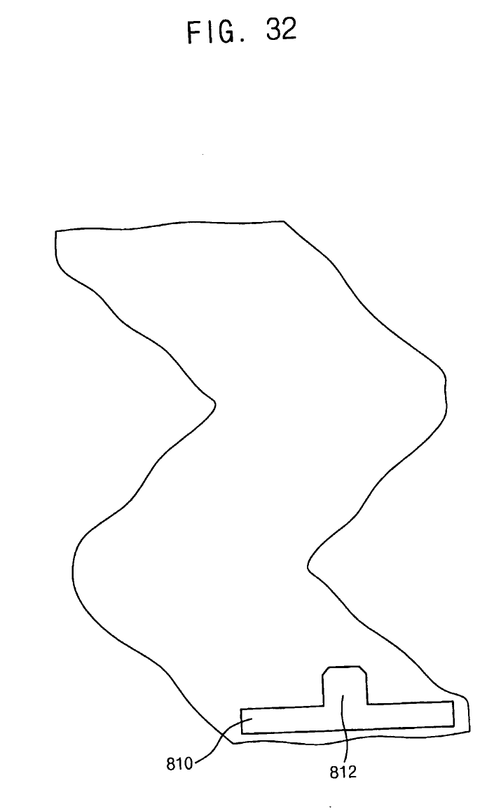

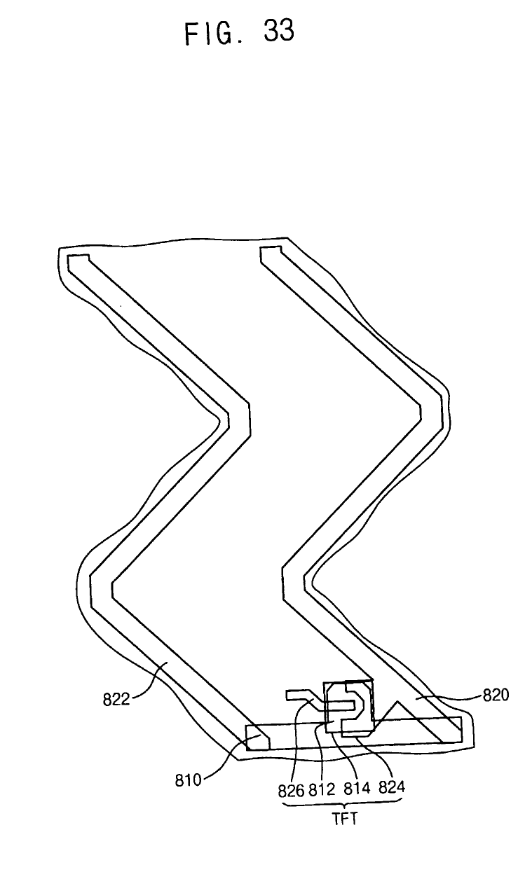

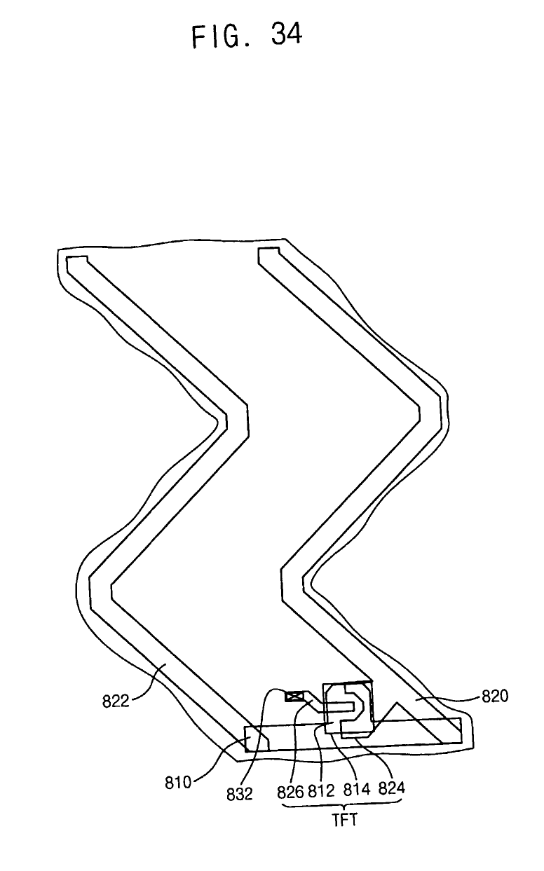

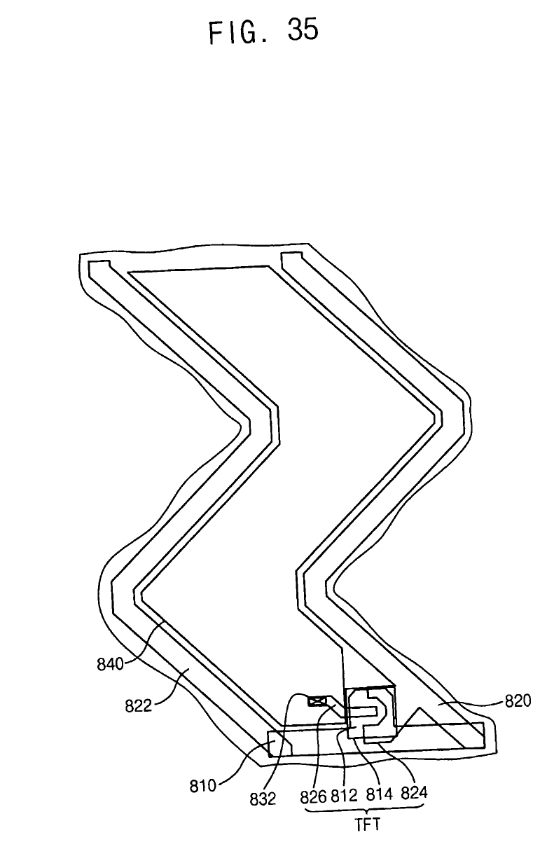

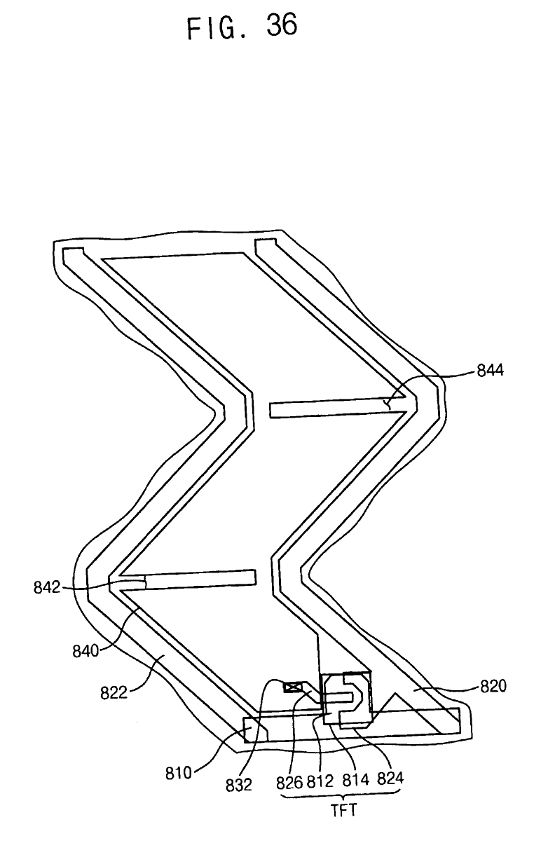

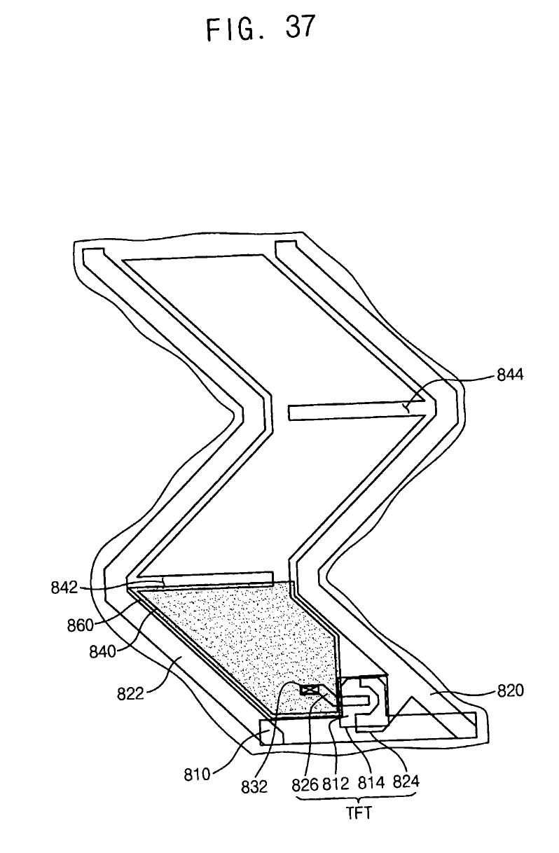

FIGS. 32, 33, 34, 35, 36, and 37 show steps for manufacturing the above embodiment. Because the steps for manufacturing this embodiment are similar to the embodiment 3 of the present invention, detail description is omitted here.

Table 1 compares above mentioned 6 cases. Example 1 is the case shown in the FIG. 1. Example 2 is the case shown in the FIGS. 2 and 3.

TABLE 1

| | Example 1 | Example 2 | Embodiment 1 | Embodiment 2 | Embodiment 3 | Embodiment 4 |
|---|---|---|---|---|---|---|
| LC domain direction | 1 | 4 | 4 | 4 | 4 | 4 |
| Transmissive aperture | 32.0 | 43.5 | 44.2 | 34.5 | 33.0 | 33.4 |
| ratio (%) | | | | | | |
| Reflective aperture | 53.0 | 0 | 39.5 | 48.0 | 46.0 | 46.2 |
| ratio (%) | | | | | | |

As shown in Table 1, all the embodiments of the present invention can get wider viewing angle character compared to the Example 1 because those have 4 LC domain directions. The embodiment 3 can be said to have 4 domains in view of the arrangement of the LC molecules. The transmissive aperture ratio of the embodiments of the present invention is not bad compared to the Example 2. Additionally, the embodiments secured a certain amount of reflective aperture ratio.

In a similar way, the concept of the present invention can be applied to an in plane switching (IPS) mode LCD. A pixel electrode area and a common electrode area of an IPS mode LCD do not have good transmission efficiency. Those areas may be used as a reflective mode area.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An array substrate, comprising:
a pixel electrode having an opening or a protrusion; and
a reflective layer overlapping the opening.

2. The array substrate of claim 1,
wherein the reflective layer is formed on the pixel electrode layer.

3. The array substrate of claim 1, further comprising:
a transparent interlayer between the pixel electrode and the reflective layer.

4. The array substrate of claim 1, further comprising:
a scan line extending to a first direction;
a data line extending to a second direction and having a bending portion:
a chevron shape pixel area defined by the scan line and the data line:
a switch formed in the pixel area,
wherein the pixel electrode is coupled with the switch.

5. The array substrate of claim 4,
wherein the chevron shape bends at about 90 degree, and the switch is a TFT

6. The array substrate of claim 1, further comprising:
a scan line extending to a first direction;
a data line extending to a second direction;
a pixel area defined by the data line and the scan line;
a switch formed in the pixel area,
wherein the pixel area shapes rectangular.

7. The array substrate of claim 1, further comprising:
a scan line extending to a first direction;
a data line extending to a second direction;
a switch formed in a pixel area defined by the scan line and the data line;
wherein the data line bends at least twice in the pixel area.

8. The array substrate of claim 7,
wherein the bending angles are about 90 degree.

9. The array substrate of claim 7,
wherein the pixel electrode has an opening at the bending portion.

10. The array substrate of claim 9,
wherein the reflective layer is substantially parallel with the data line.

11. The array substrate of claim 9,
wherein the reflective area extends from the switch to a first bending area.

12. A method for manufacturing an array substrate, comprising;
forming a scan line, a data line, a switch electrically coupled to the scan line and the data line;
forming a pixel electrode having an opening or a protrusion to form a plurality of LC domains; and
forming a reflective layer at the domain boundary.

13. The method of claim 12,
wherein the data line has a bending portion in a pixel area, and
having an opening or a protrusion in the pixel electrode at the bending area.

14. The method of claim 12, wherein
the data line is straight in a unit pixel area; and
the pixel electrode has a first direction opening or protrusion being 45 degree from the scan line, a second direction opening or protrusion being 45 degree from the scan line, and a third direction opening or protrusion being parallel with the scan line.

15. The method of claim 12,
wherein the data line has at least two bending portion, and
the pixel electrode has an opening or a protrusion in the bending portion and parallel with the scan line

16. A liquid crystal display, comprising:
a liquid crystal layer;
a first substrate;
a common electrode formed on the first substrate;
a plurality of first openings or protrusions formed in the common electrode;
a second substrate;
a pixel electrode formed on the second substrate;
a plurality of second openings or protrusions formed in the pixel electrode;
a reflective layer formed on the second substrate;
wherein the LC layer is confined between the first substrate and the second substrate and the reflective layer overlaps with the first openings or protrusions and the second openings or protrusions.

17. The LCD of claim 16,
wherein the number of the LC domains is 4 in a pixel area.

18. The LCD of claim 16,
wherein the data line has at least one bending portion in one pixel region.

19. The LCD of claim 16,
wherein the pixel shape is chevron or rectangular.

20. The LCD of claim 16,
wherein the pixel has at least one bending portion, and
the pixel has a zigzag shape.
